(19) United States
(12) Patent Application Publication
(10) Pub. No.: US 2015/0185491 A1
(43) Pub. Date: Jul. 2, 2015

(54) Optical Imaging Apparatus

(71) Applicants: Ya-Chuang Huang, Zhubei City (TW); Tang-Hung Po, Zhubei City (TW); Theia Limited, Zhubei City (TW)

(72) Inventors: Ya-Chuang Huang, Zhubei City (TW); Tang-Hung Po, Zhubei City (TW)

(21) Appl. No.: 14/583,863

(22) Filed: Dec. 29, 2014

Related U.S. Application Data
(60) Provisional application No. 61/921,584, filed on Dec. 30, 2013.

(51) Int. Cl. G02B 27/22; H04N 13/02; G02F 1/1335; G02B 5/09; G02F 1/13

(52) U.S. Cl. CPC G02B 27/2292; G02B 5/09; G02F 1/1313; G02F 1/133553; H04N 13/0296; H04N 13/0242

(57) ABSTRACT

An optical imaging apparatus is provided. The optical imaging apparatus includes a micro reflective mirror assembly and at least one imaging source. The micro reflective mirror assembly is mainly comprised of multiple micro reflective mirrors, and each micro reflective mirror has a first focus. The first focus of each micro reflective mirror is different from the first focus of other micro reflective mirror, and all the first focuses constitute a first focus group. A plurality of light emitted from the imaging source is reflected by the micro reflective mirror assembly so as to form an image in a first region that the first focus group defines.

### BACKGROUND OF THE INVENTION

1. Field of Invention

The present invention relates to an optical imaging apparatus, especially relates to an optical imaging apparatus for forming a real image in the air.

2. Description of Related Art

Nowadays, many movies film with 3D rendering, and also there is many TV manufacturers launching 3D TV in order to allow consumers to view the stereoscopic images. However, whether it is 3D movies or 3D TV, most consumers are required to wear stereoscopic glasses (3D glasses), and this will cause inconvenience to the consumer. To solve this problem, it was suggested that the naked eye 3D technology. But whether the technique that needs consumers to wear stereoscopic glasses or naked eye 3D technology, they are both based on the principle of binocular parallax, and cannot produce real three-dimensional images, but since there is no real image, so there is a limited range of applications.

Some people having ordinary skill in the art disclose the techniques of forming real image in the air. For example, an optical imaging apparatus operable to form a sharp stereo image in the air beside an observer is provided in U.S. Pat. No. 8,702,252. However, an optical imaging apparatus disclosed in U.S. Pat. No. 8,702,252 has disadvantages of high cost and is not easy to produce.

Hence, there is a need in the art for providing an optical imaging apparatus operable to form a real image in the air that has advantage low cost and is easy to produce.

### SUMMARY OF THE INVENTION

One aspect of the invention is to provide an optical imaging apparatus. The optical imaging apparatus that has advantage low cost and is easy to produce can form a real image in the air.

To achieve the foregoing and other aspects, an optical imaging apparatus is provided. The optical imaging apparatus includes a micro reflective surface assembly and at least one imaging source. The micro reflective surface assembly is mainly comprised of multiple micro reflective surfaces, and each micro reflective surface has a first focus. The first focus of each micro reflective surface is different from the first focus of other micro reflective surface, and all the first focuses constitute a first focus group. A plurality of light emitted from the imaging source is reflected by the micro reflective surface assembly so as to form an image in a first region that the first focus group defines. In the present invention, the reflective surface is defined as a surface that can reflect light or electromagnetic radiation.

In the optical imaging apparatus, the micro reflective surfaces are micro reflective mirrors. The micro reflective mirrors are ellipse mirrors, each micro reflective mirror has a second focus, and all the second focuses constitute a second focus group. The imaging source is placed in a second region that the second focus group defines, and the light emitted from the imaging source is reflected by the micro reflective mirror assembly so as to form the image in the first region.

In addition, the optical imaging apparatus further includes a non-transparent partition plate, and the non-transparent partition plate has a hole. The light emitted from the imaging source is incident on the micro reflective mirror array after passing through the hole. In one embodiment, a lens is disposed in the hole, and the lens is configured to pre-equalize the light emitted from the imaging source so as to prevent an image distortion.

In the optical imaging apparatus, the micro reflective mirrors are parabolic mirrors. The light emitted from the imaging source is parallel light for the micro reflective mirrors, and the light emitted from the imaging source is reflected by the micro reflective mirror assembly so as to form the image in the first region.

Furthermore, the optical imaging apparatus further includes a positioning device, and the positioning device is configured to control and adjust the position of the micro reflective mirror assembly.

In addition, the optical imaging apparatus further includes a transparent plate. The transparent plate is placed between the image and the micro reflective mirror assembly, and configured to pre-equalize the light emitted from the imaging source so as to prevent an image distortion.

In the optical imaging apparatus, the imaging source is a display device.

To achieve the foregoing and other aspects, another optical imaging apparatus is provided. The optical imaging apparatus includes a display device and a pixel control device. A plurality of first pixel groups is disposed on a screen of the display device, and each first pixel group comprising a plurality of first pixels. The pixel control device is placed on the display device, and the pixel control device includes a plurality of second pixel groups. Each second pixel group includes a plurality of second pixels, and each second pixel group is corresponding to one of the first pixel groups. When one of the first pixel groups is lit, the corresponding second pixel group will be open so as to make the light emitted from the first pixel groups pass through the second pixel group and concentrate on one point.

In the optical imaging apparatus, the pixel control device includes a liquid crystal layer, and the liquid crystal layer is configured to control a state of the second pixel.

In addition, the optical imaging apparatus further includes a handhold wireless signal transmitter, at least three wireless signal receivers, and a processing unit. The wireless signal receivers are configured to receive a wireless signal emitted from the handhold wireless signal transmitter. The processing unit is electrically connected to the wireless signal receivers, and the processing unit is configured to determine a position of the handhold wireless signal transmitter according to a signal transmitted from the wireless signal receivers.

In the optical imaging apparatus, after the wireless signal is received by the wireless signal receivers, the light emitted from one of the first pixel groups is concentrated on a position of the handhold wireless signal transmitter.

In the optical imaging apparatus, the light emitted from the optical imaging apparatus is configured to form an image on a moving track of the handhold wireless signal transmitter.

In the optical imaging apparatus, the wireless signal receivers is placed the periphery of the pixel control device.

In the optical imaging apparatus, the optical imaging apparatus is configured to form an image by scanning a region at a specific frequency, and the specific frequency is larger than 60 Hz.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a first embodiment of an optical imaging apparatus in the invention.

FIG. 2A shows the micro reflective mirror assembly in the first embodiment.

FIG. 2B shows a second embodiment of an optical imaging apparatus in the invention.

FIG. 3A shows a third embodiment of an optical imaging apparatus in the invention.

FIG. 3B shows the relationship between the light emitted from the second focus and the non-transparent partition plate.

FIG. 3C shows a fourth embodiment of an optical imaging apparatus in the invention.

FIG. 4A shows the image displayed on the screen of the imaging source.

FIG. 4B shows the image formed in the region A if the lens was not disposed in the hole of the non-transparent partition plate.

FIG. 4C shows the image after the light passing through the lens.

FIG. 5A shows a fifth embodiment of an optical imaging apparatus in the invention.

FIG. 5B shows the micro reflective mirror assembly in the fifth embodiment.

FIG. 5C shows a variant embodiment of an optical imaging apparatus in the fifth embodiment.

FIG. 6 shows a sixth embodiment of an optical imaging apparatus in the invention.

FIG. 7 shows the images formed by the optical imaging apparatus in the sixth embodiment.

FIG. 8 shows a seventh embodiment of an optical imaging apparatus in the invention.

FIG. 9A˜FIG. 9C show the operation of the optical imaging apparatus in the seventh embodiment.

FIG. 10 show the operation of the optical imaging apparatus in the another embodiment.

FIG. 11 shows an eighth embodiment of an optical imaging apparatus in the invention.

FIG. 12 shows the block diagram in the eighth embodiment.

FIG. 13 shows the operation in the eighth embodiment.

### DESCRIPTION OF EMBODIMENTS

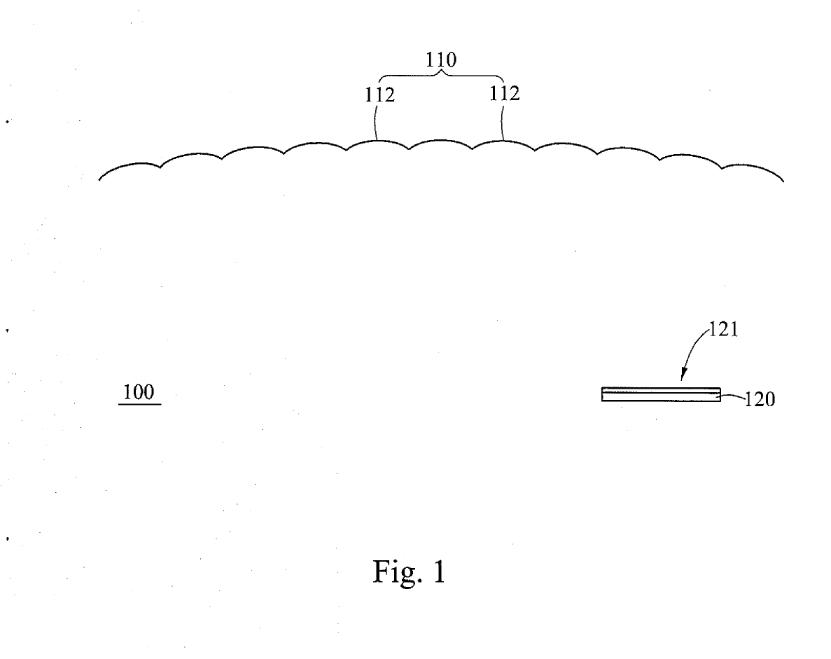

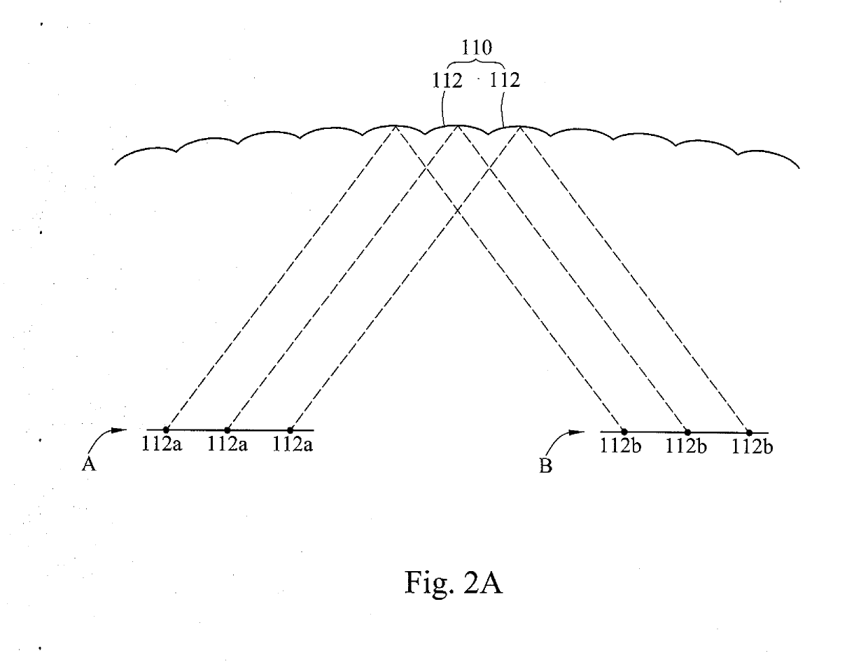

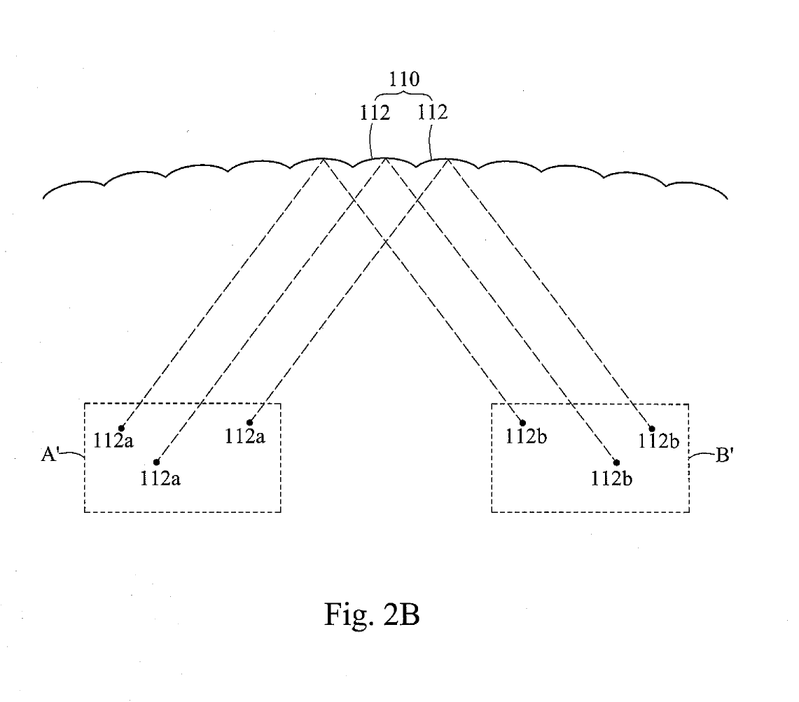

Please refer to FIG. 1 which shows a first embodiment of an optical imaging apparatus in the invention. In the embodiment, the optical imaging apparatus 100 includes a micro reflective mirror assembly 110 and an imaging source 120. The micro reflective mirror assembly 110 is mainly comprised of multiple micro reflective mirrors 112, and the imaging source 120 is a display device, for example: liquid crystal display, in the embodiment. Please refer to FIG. 2A which shows the micro reflective mirror assembly in the first embodiment. The micro reflective mirror 112 is an ellipse mirror, i.e. the micro reflective mirror 112 can be viewed as part of a surface of an ellipsoid. Thus, each micro reflective mirror has a first focus 112a and a second focus 112b. The first focus112a and the second focus 112b of each micro reflective mirror 112 are respectively different from the first focus112a and the second focus 112b of other micro reflective mirror 112. Furthermore, the micro reflective mirrors 112 are ellipse mirrors, so a plurality of light emitted from the second focus 112b is focused on the first focus112a after being reflected by the micro reflective mirrors 112, and vice versa. All the first focuses 112a constitute a first focus group, and all the second focuses 112b constitute a second focus group. A region defined by the first focuses 112a is a first region A, and a region defined by the second focuses 112a is a second region B. In the embodiment, the second region B is disposed on a screen 121 of the display device 120, so the image displayed on the screen 121 can be reproduced as a real image in the region A.

In the above embodiment, the first region A and the second region B are both planes. However, in other embodiments, the first region or the second region can also be a three dimensional space (shown in FIG. 2B). Instead of totally being disposed on a plane, the first focuses 112a are disposed in a three dimensional space (a first region A′), and the second focuses 112b are also disposed in another three dimensional space (a second region B′). Therefore, the image source placed in the second region B′ can be a lighting sphere (not shown), and thus a spherical real image is formed in the first region A′. In addition, the number of the image sources is not limited to one, but also for multiple.

In the above two embodiments, the image source is located in the second region B, but the image source can also be located outside the second region B dependent on the situation. Or, in other embodiment, some portion of the image source is disposed in the second region B, and the other portion of the image source is disposed outside the second region B.

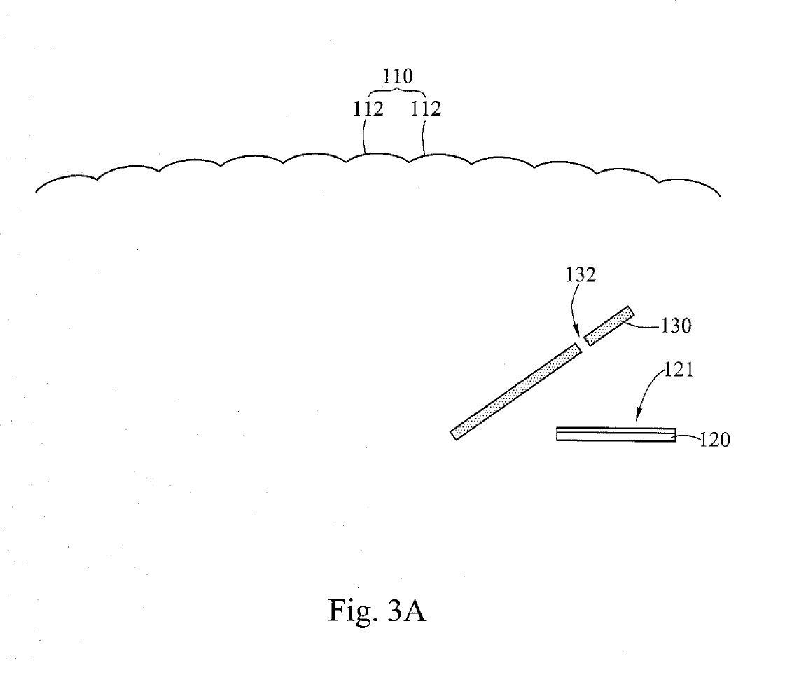

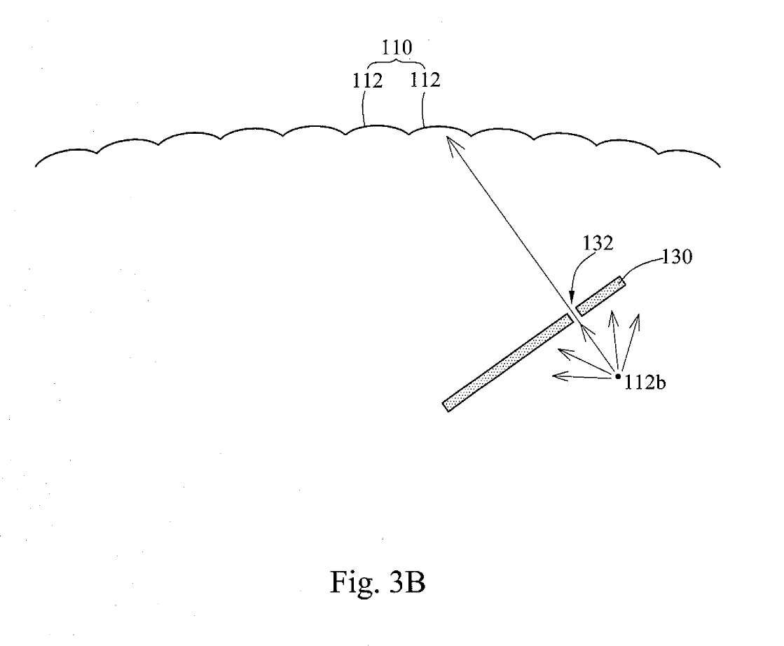

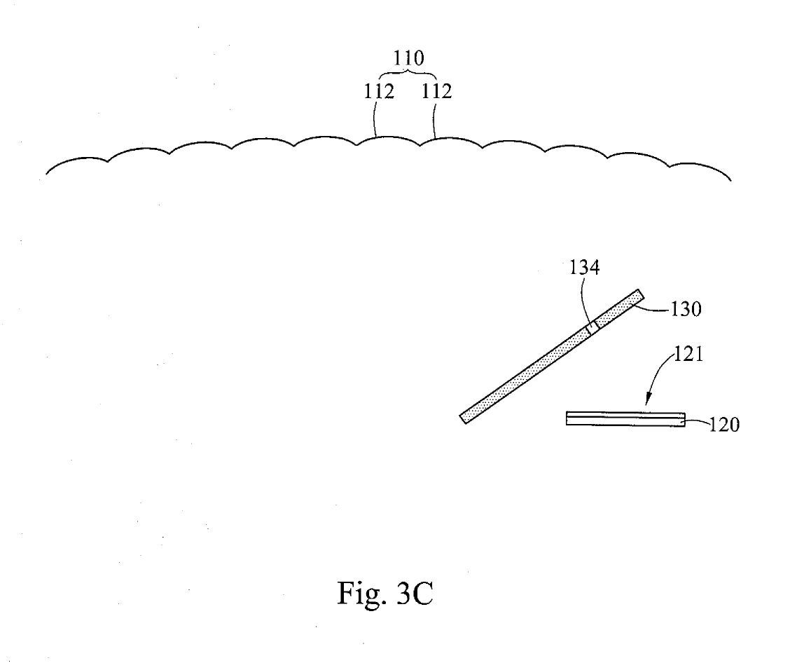

Please refer to FIG. 3A which shows a third embodiment of an optical imaging apparatus in the invention. In the third embodiment, the optical imaging apparatus 300 further includes a non-transparent partition plate 130. The non-transparent partition plate 130 is placed between the micro reflective mirror assembly 110 and the second region B. In other words, the non-transparent partition plate 130 is placed between the micro reflective mirror assembly 110 and the image source 120. The non-transparent partition plate 130 has a hole 132. The light emitted from the imaging source 120 is incident on the micro reflective minor assembly 110 after passing through the hole 132, then the light is reflected by the micro reflective mirror array so as to form a real image in the region A (as shown in FIG. 2A). Please refer to FIG. 3B. In FIG. 3B, only some portion of the light emitted from the second focus 112b is passing through the hole 132, and other portion of the light is blocked out by the non-transparent partition plate 130. The position of the hole 132 is adjusted specifically to ensure the light emitted from the second focus 112b is incident on the corresponding micro reflective mirror 112 rather than on other micro reflective mirror 112. Therefore, the real image formed on the first region A has high quality.

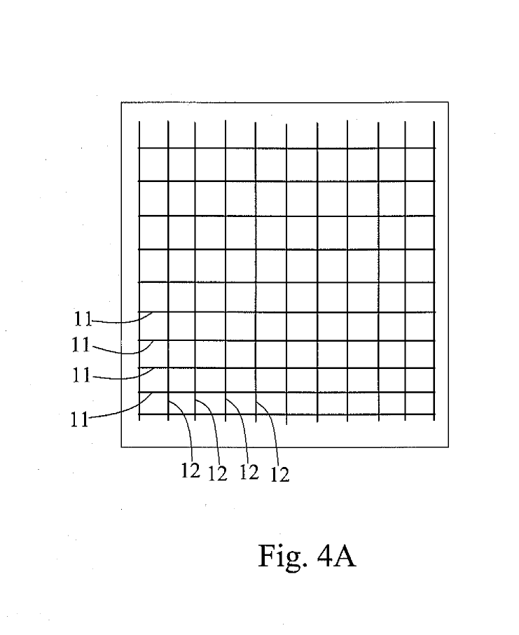

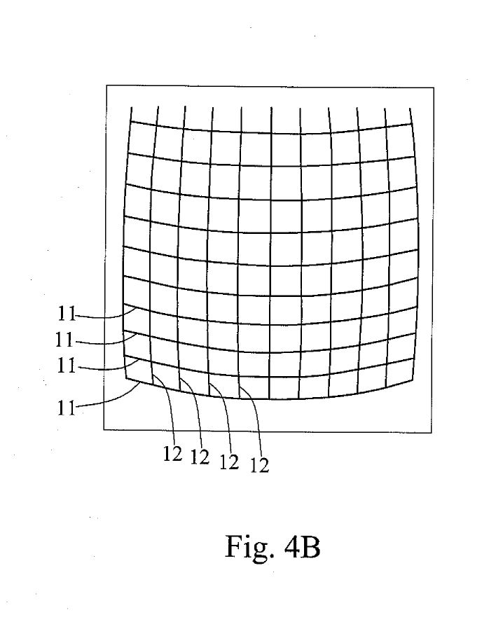

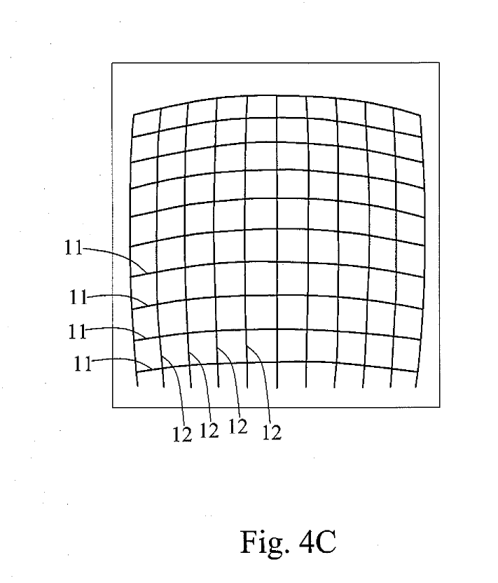

Please refer to FIG. 3C which shows a fourth embodiment of an optical imaging apparatus in the invention. In FIG. 3C, a lens 134 is disposed in the hole 132 of the non-transparent partition plate 130. The lens 134 is configured to pre-equalize the light emitted from the imaging source 120 so as to prevent an image distortion. Please refer to FIG. 4A˜FIG. 4C for clearly understanding the function of pre-equalizing. First, please refer to FIG. 4A which shows the image displayed on the screen 121 of the imaging source 120. The image is comprised of multiple horizontal lines 11 and multiple vertical lines 12 crossing across each other. If the lens 134 was not disposed in the hole 132 of the non-transparent partition plate 130, the image formed in the region A is like the image shown in FIG. 413. In FIG. 4B, the horizontal lines 11 are bent downwards, and the vertical lines 12 are bent to sides. After the light passing through the lens 134 disposed in the hole 132 of the non-transparent partition plate 130, the image formed between the non-transparent partition plate 130 and the micro reflective minor assembly 110 is shown like FIG. 4C. In FIG. 4C, the horizontal lines 11 are bent upwards, and the vertical lines 12 are bent toward the central line. In other words, the influence for the image caused by the lens 134 is opposite to the influence for the image caused by the micro reflective mirror assembly 110. Thus, due to the lens 134 disposed in the hole 132 of the non-transparent partition plate 130, the real image formed in the region A is same as or similar to the image shown in FIG. 4A.

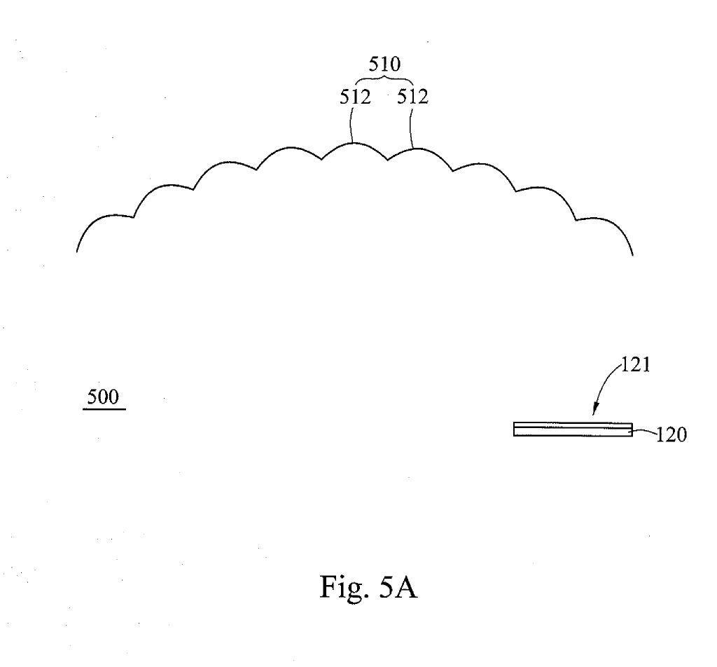

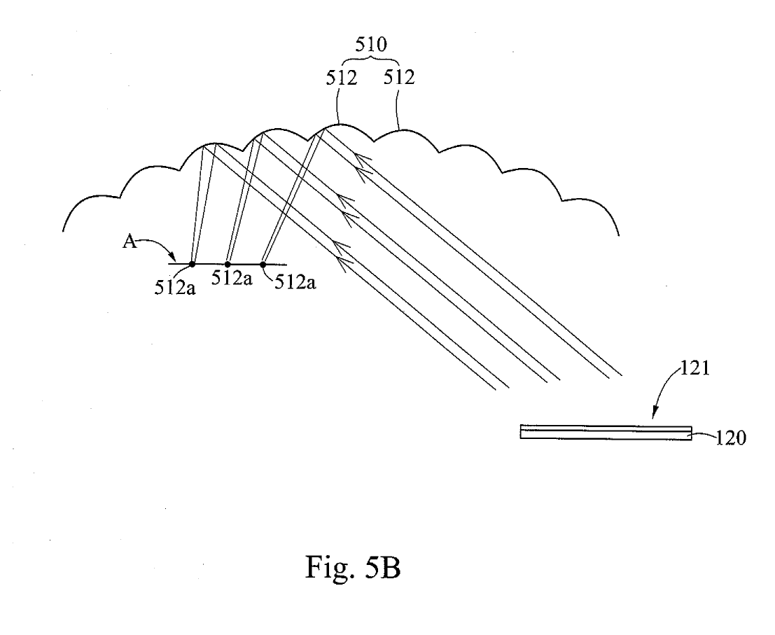

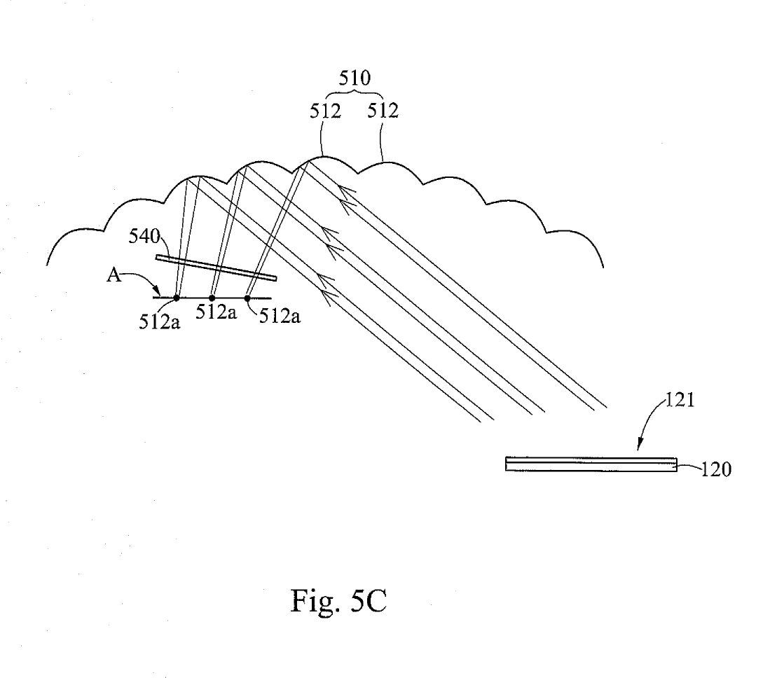

Please refer to FIG. 5A which shows a fifth embodiment of an optical imaging apparatus in the invention. In the fifth embodiment, the optical imaging apparatus 500 includes a micro reflective mirror assembly 510 and an imaging source 120. The micro reflective minor assembly 510 is mainly comprised of multiple micro reflective mirrors 512, and the imaging source 120 is a display device, for example: liquid crystal display, in the embodiment. Please refer to FIG. 5B which shows the micro reflective minor assembly in the fifth embodiment. The micro reflective mirror 512 is a parabolic minor, i.e. the micro reflective mirror 512 can be viewed as part of a parabolic surface. Thus, each micro reflective mirror has a first focus 512a. The first focus 512a of each micro reflective mirror 512 is different from the first focus512a of other micro reflective mirror 512. Furthermore, the micro reflective mirror 512 is a parabolic mirror, so the parallel light is focused on the first focus 512a after being reflected by the micro reflective minors 510. All the first focuses 512a constitute a first focus group. A region defined by the first focuses 512a is a first region A. In the embodiment, the display is placed far enough so that the light emitted from the display can be viewed as parallel light. Therefore, due to the micro reflective minor assembly 510, the image shown on the screen 121 of the display 120 can be reproduced in the first region A.

Furthermore, please refer to FIG. 5C which shows a variant embodiment of an optical imaging apparatus in the fifth embodiment. The optical imaging apparatus 600′ further includes a transparent plate 540. The transparent plate 540 is made of glass material and placed between the first region A and the micro reflective minor assembly 510. The transparent plate 540 is configured to pre-equalize the light emitted from the imaging source 120 so as to prevent an image distortion. The function of pre-equalizing has been described in detail in FIG. 4A˜FIG. 4C, so not described again here.

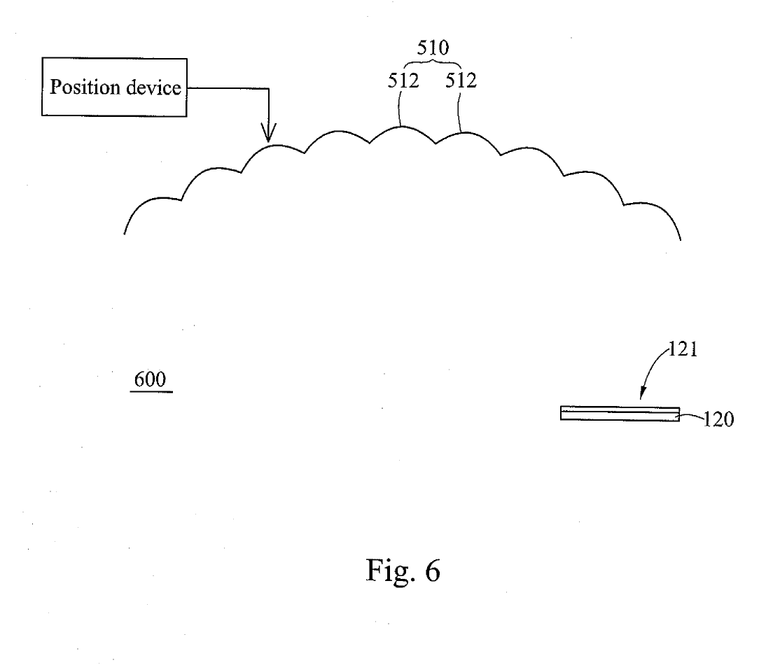

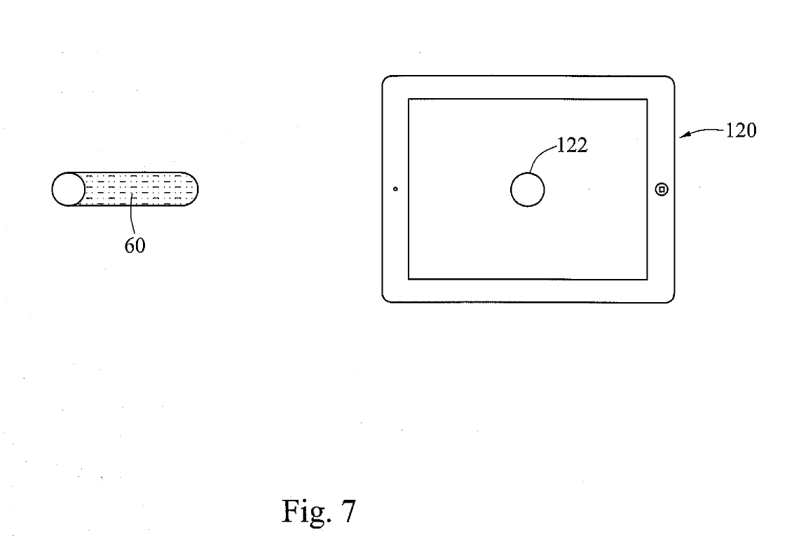

Please refer to FIG. 6 which shows a sixth embodiment of an optical imaging apparatus in the invention. In the sixth embodiment, the optical imaging apparatus 600 further includes a positioning device 530. The positioning device 530 is configured to control and adjust the position of the micro reflective mirror assembly 510, i.e. the position of the first region A (the region defined by the first focus group) can be adjusted. Thus, the position of the real image can be adjusted so that the viewer feels the real image in the mobile. In addition, the micro reflective mirror assembly 510 can be moved in a cycle above a specific frequency (for example: 60 Hz) so as to produce the persistence of vision effect. Thus, as shown in FIG. 7, a circle line 122 is shown on the micro reflective mirror assembly 510 (as shown in right side of FIG. 7), but by moving the micro reflective mirror assembly 510 periodically above the specific frequency, the viewer feels the tube image is formed in the region A (as shown in left side of FIG. 7).

In the above embodiment, the micro reflective mirrors can be replaced by other micro reflective surfaces, for example: reflective glass.

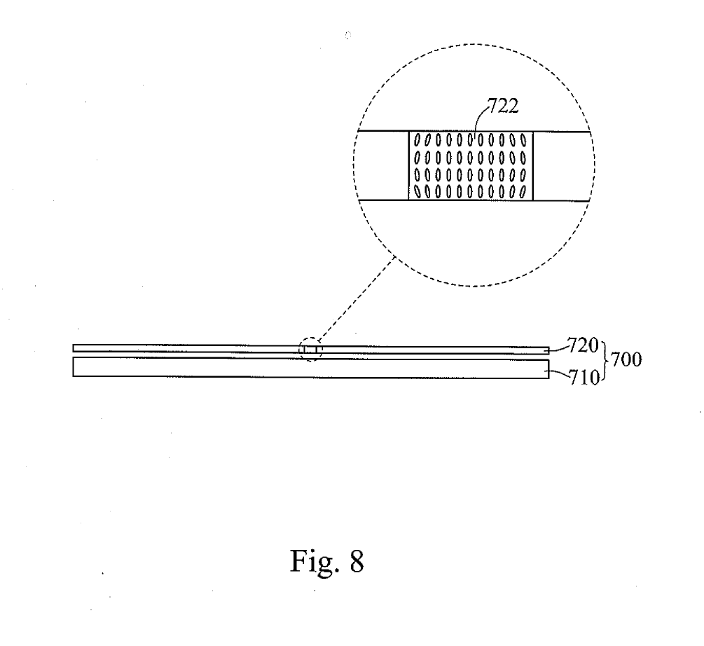

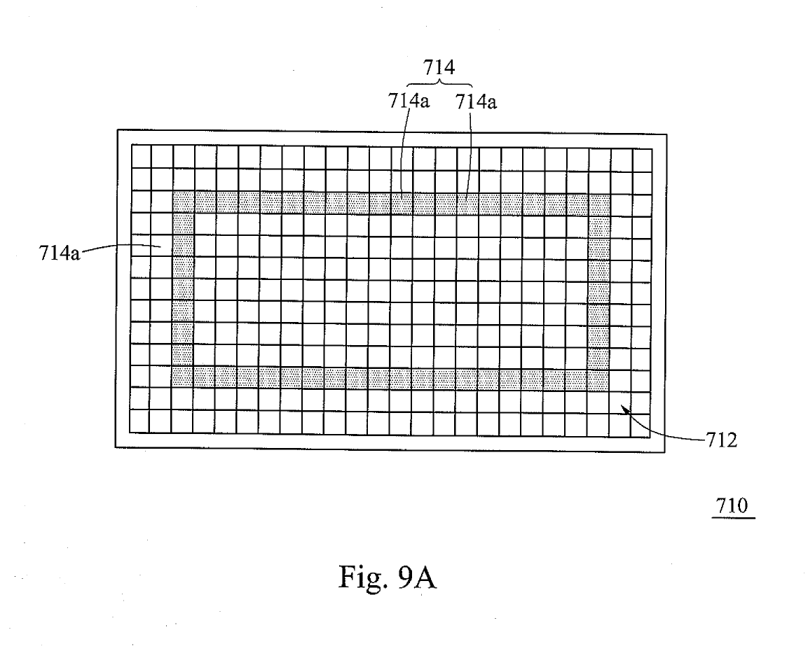

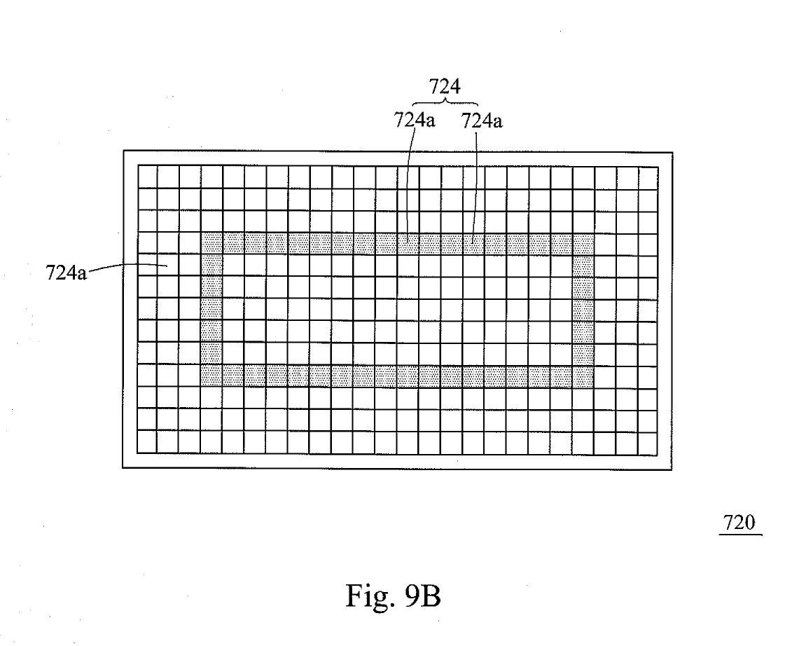

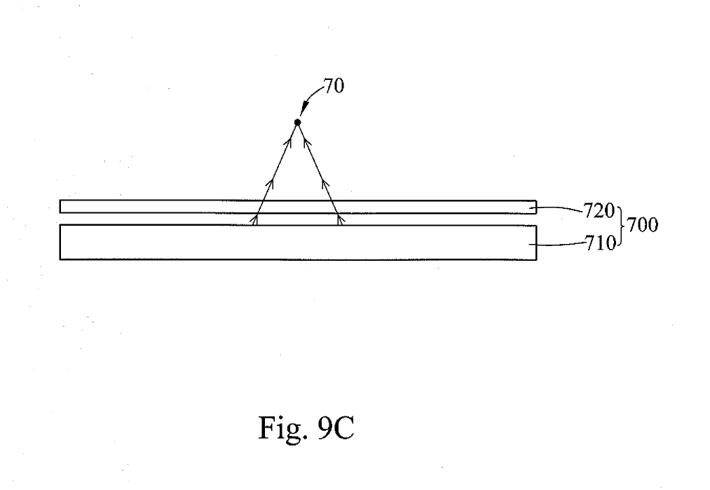

Please refer to FIG. 8 which shows a seventh embodiment of an optical imaging apparatus in the invention. The optical imaging apparatus 700 includes a display device 710 and a pixel control device 720, and the pixel control device 720 is placed on the pixel control device 720. In the seventh embodiment, the display device 710 is a liquid crystal display. A plurality of first pixels 714a is disposed on a screen 712 of the display device 710 as shown in FIG. 9A. The pixel control device 710 includes a plurality of second pixels 724a and a liquid crystal layer 722 (shown in FIG. 8) is disposed in the pixel control device 720. By controlling the arrangement of the liquid crystal in the liquid crystal layer 722, the light can be controlled by the second pixel 724a.

In FIG. 9A, the lighting first pixels 714a are defined or named as a first pixel group 714 and represented as oblique lines. In FIG. 9B, the opening second pixels 724a are defined or named as a second pixel group 724 and represented as oblique Tines. Please refer to FIG. 9A˜FIG. 9C. The second pixel group 714 is open when the first pixel group 714 is lighting, and the light emitted from the first pixel group 714 is converged at one image forming point 70 after passing the second pixel group 724. The position of the image forming point 70 is determined by controlling the relative position of the first pixel group 714 and the second pixel group 724.

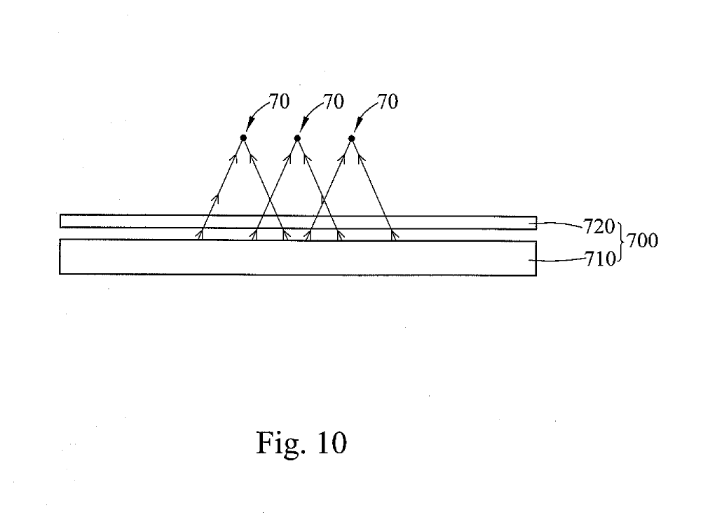

In FIG. 9A˜FIG. 9C, only one first pixel group 714 and its corresponding second pixel group 724 are operable at the same time. In other embodiment, multiple first pixel groups 714 and multiple second pixel groups 714 are operable at the same time so as to form a plurality of imaging forming points 70 (shown in FIG. 10), and these imaging forming points 70 constitute an image or a part of the image. In addition, due to persistence of vision, even if the imaging forming points 70 constitute only a part of the image, by shifting the positions of the imaging forming points 70 fast and periodically the user can feel the complete image formed in the air.

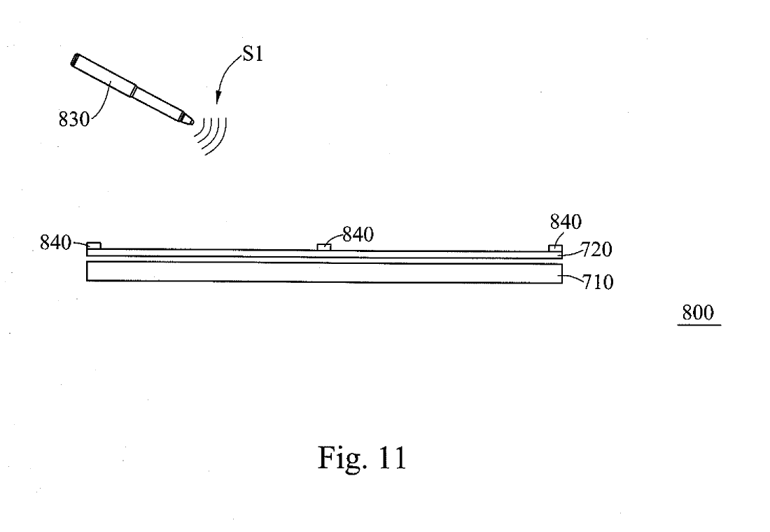

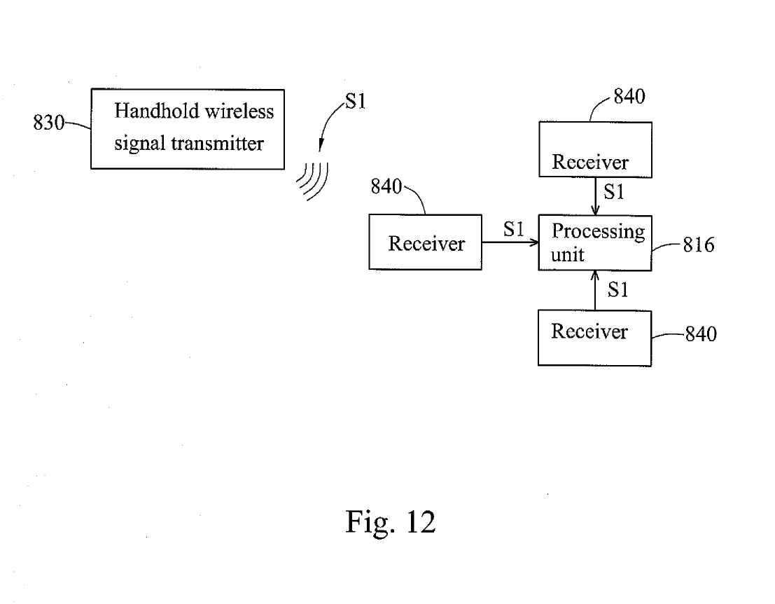

Please refer to FIG. 11 which shows an eighth embodiment of an optical imaging apparatus in the invention. In the eighth embodiment, the optical imaging apparatus 800 further includes a handhold wireless signal transmitter 830 and at least three wireless signal receivers 840. The wireless signal receivers 840 are disposed on the pixel control device 720, for example: on the frame of the pixel control device 720. Please refer to FIG. 12. The handhold wireless signal transmitter is configured to transmit a wireless signal S1. After receiving the wireless signal S1, the wireless signal receivers 840 generate and send a signal S2 to a processing unit 816. The processing unit 816 determines the position of the handhold wireless signal transmitter 830 according to the signal S2 transmitted from the wireless signal receivers 840. In the embodiment, the processing unit 816 is disposed in the display device 710.

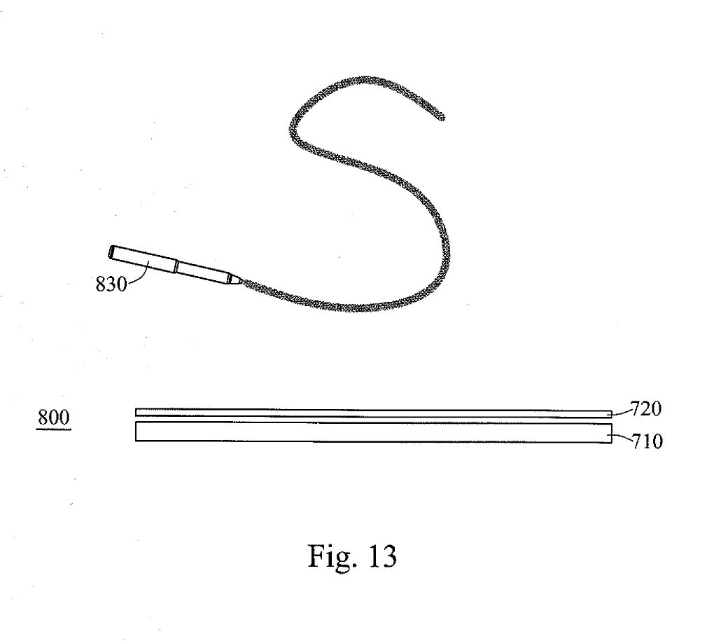

A user can do various operations by using the handhold wireless signal transmitter 830. For example, the optical imaging apparatus 800 can form a menu image (not shown) in the air, and the user can use the handhold wireless signal transmitter 830 to touch the menu image. In other embodiment (shown in FIG. 13), the user can use the handhold wireless signal transmitter 830 to draw a picture in the air. In other words, the optical imaging apparatus 800 can form the image along the track that the handhold wireless signal transmitter 830 passed through.

In the above embodiments, the optical imaging apparatus forms the image directly in the air. However, in other embodiment, the optical imaging apparatus further includes a spray device and projects the image in the mist produced by the spray device. In another embodiment, the optical imaging apparatus is disposed in the meeting table and projects the subject matter or data for discussion in the air. In yet another embodiment, the optical imaging apparatus is disposed in the dining table and projects the menu and dishes in the air. In yet another embodiment, the optical imaging apparatus is disposed in the shopping mall or the department store and projects the commodity in the air. In this way, the consumer can see the real look of the commodity even if the package of the commodity is not open.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. An optical imaging apparatus, comprising:
a micro reflective surface assembly, mainly comprised of multiple micro reflective surfaces, each micro reflective surface has a first focus, the first focus of each micro reflective surface is different from the first focus of other micro reflective surface, and all the first focuses constitute a first focus group; and
at least one imaging source;
wherein a plurality of light emitted from the imaging source is reflected by the micro reflective surface assembly so as to form an image in a first region that the first focus group defines.

2. The optical imaging apparatus of claim 1, wherein the micro reflective surfaces are micro reflective mirrors.

3. The optical imaging apparatus of claim 2, wherein the micro reflective mirrors are ellipse mirrors, each micro reflective mirror has a second focus, and all the second focuses constitute a second focus group.

4. The optical imaging apparatus of claim 3, wherein the imaging source is placed in a second region that the second focus group defines, the light emitted from the imaging source is reflected by the micro reflective mirror assembly so as to form the image in the first region.

5. The optical imaging apparatus of claim 3, further comprising a non-transparent partition plate, wherein the non-transparent partition plate has a hole, the light emitted from the imaging source is incident on the micro reflective mirror array after passing through the hole.

6. The optical imaging apparatus of claim 5, wherein a lens is disposed in the hole, the lens is configured to pre-equalize the light emitted from the imaging source so as to prevent an image distortion.

7. The optical imaging apparatus of claim 2, wherein the micro reflective mirrors are parabolic mirrors.

8. The optical imaging apparatus of claim 7, wherein the light emitted from the imaging source is parallel light for the micro reflective mirrors, the light emitted from the imaging source is reflected by the micro reflective mirror assembly so as to form the image in the first region.

9. The optical imaging apparatus of claim 1, further comprising a positioning device, wherein the positioning device is configured to control and adjust the position of the micro reflective surface assembly.

9. The optical imaging apparatus of claim 7, further comprising a transparent plate, wherein the transparent plate is placed between the first region and the micro reflective mirror assembly, and configured to pre-equalize the light emitted from the imaging source so as to prevent an image distortion.

10. The optical imaging apparatus of claim 1, further comprising a positioning device, wherein the positioning device is configured to control and adjust the position of the micro reflective surface assembly.

11. The optical imaging apparatus of claim 1, wherein the imaging source is a display device.

12. An optical imaging apparatus, comprising:
a plurality of first pixel groups is disposed on a screen of the display device, and each first pixel group comprising a plurality of first pixels; and
a pixel control device, placed on the display device, the pixel control device comprising a plurality of second pixel groups, each second pixel group comprising a plurality of second pixels, and each second pixel group is corresponding to one of the first pixel groups;
wherein, when one of the first pixel groups is lit, the corresponding second pixel group will be controlled so as to make the light emitted from the first pixel groups pass through the second pixel group and concentrate on one point.

13. The optical imaging apparatus of claim 12, wherein the pixel control device comprises a liquid crystal layer.

14. The optical imaging apparatus of claim 12, further comprising:
a handhold wireless signal transmitter;
at least three wireless signal receivers, the wireless signal receivers configured to receive a wireless signal emitted from the handhold wireless signal transmitter; and
a processing unit, the processing unit electrically connected to the wireless signal receivers, wherein the processing unit is configured to determine a position of the handhold wireless signal transmitter according to a signal transmitted from the wireless signal receivers.

15. The optical imaging apparatus of claim 14, wherein after the wireless signal is received by the wireless signal receivers, the light emitted from one of the first pixel groups is concentrated on a position of the handhold wireless signal transmitter.

16. The optical imaging apparatus of claim 14, wherein the light emitted from the optical imaging apparatus is configured to form an image on a moving track of the handhold wireless signal transmitter.

17. The optical imaging apparatus of claim 14, wherein the wireless signal receivers is placed the periphery of the pixel control device.

18. The optical imaging apparatus of claim 12, wherein the optical imaging apparatus is configured to form an image by scanning a region at a specific frequency.

19. The optical imaging apparatus of claim 18, wherein the specific frequency is larger than 60 Hz.
